(19) United States
(12) Patent Application Publication
(10) Pub. No.: US 2011/0278030 A1
(43) Pub. Date: Nov. 17, 2011

(54) WEEDING METHOD AND APPARATUS

(76) Inventor: David Kohler, Pasco, WA (US)

(21) Appl. No.: 13/108,197

(22) Filed: May 16, 2011

Related U.S. Application Data
(60) Provisional application No. 61/345,241, filed on May 17, 2010.

(51) Int. Cl. A01B 39/18; A01B 79/00; A01B 39/08

(52) U.S. Cl. 172/1; 172/526; 172/111

(57) ABSTRACT

In orchards or fields of grape vines, weeding in inter-plant spaces may be performed with a mechanical weeder. The weeder may include a frame configured to be propelled by a motorized vehicle. A rotatable weeder unit may be pivotally connected to a pivot arm attached to the frame and a spring may be connected to hold the rotatable weeder unit in a nominal pivotal position relative to the frame responsively to a force exerted by the spring. When encountering a producing plant, the weeder unit may deflect away from the plant thereby precluding damage to the plant.

### RELATED APPLICATIONS

The application claims the benefit of US Provisional Application No. 61/345,241 filed on May 17, 2010.

### BACKGROUND OF THE INVENTION

The present invention generally relates to agricultural systems for eliminating undesired vegetation in regions near or adjacent to fruit or nut bearing plants.

In a typical agricultural setting in which fruit or nuts may be produced, plants are arranged in rows with substantially equal spacing between the rows. Spaces between the rows may be wide enough to allow passage of machinery such a tractors or trucks.

Undesirable vegetation, i.e., weeds, may grow in these spaces. These weeds may be periodically removed with chemicals or motorized machinery such as mowers, cultivators or tillers. Such weed removal operations may be relatively easy to perform in most areas of the inter-row spaces. However, in certain regions of the inter-row spaces, in close proximity to the fruit or nut bearing plants, there is a risk that conventional weed removal may result in damage to the plants. Thus a farmer may forego weed removal in these close proximity areas.

Ironically, weeds growing in these close proximity areas may have a particularly deleterious effect on productivity of the fruit or nut bearing plants. In other words, a weed that is close to a plant may absorb more nutrients and moisture from a productive plant's roots than a weed that is far from the plant.

As can be seen, there is a need for a system that may be employed to remove weeds from inter-row spaces in areas that are in close proximity to producing fruit or nut bearing plants.

### SUMMARY OF THE INVENTION

In one aspect of the present invention, a mechanical weeder may comprise a frame configured to be propelled by a motorized vehicle; a rotatable weeder unit pivotally connected to a pivot arm attached to the frame; and a spring connected to hold the rotatable weeder unit in a nominal pivotal position relative to the frame responsively to a force exerted by the spring.

In another aspect of the present invention, a deflectable weeder assembly attachable to a motorized vehicle may comprise a pivot arm fixedly attachable to the vehicle; a wheel freely rotatable about a wheel axis; and a spring-biased wheel support rotatable about the pivot arm, the wheel being connected to the spring-biased wheel support with the wheel axis being displaced from the pivot arm.

In still another aspect of the invention, a method for removing weeds from rows of fruit or nut bearing plants may comprise the steps of inserting a portion of a wheel into a berm adjacent one of the rows; pushing the wheel along the berm with a motorized vehicle while allowing the wheel to freely rotate about its wheel axis and while maintaining the wheel axis within 10° of vertical; maintaining the wheel axis in a nominal position relative to the vehicle with a predetermined spring-bias force whenever the wheel is not subjected to wheel contact force that is less than the predetermined force; and allowing the wheel to deflect from the nominal position whenever the wheel contact force exceeds the predetermined spring-bias force.

These and other features, aspects and advantages of the present invention will become better understood with reference to the following drawings, description and claims.

### BRIEF DESCRIPTION OF THE DRAWINGS

FIG. 1 is a perspective view of an agricultural setting in which the invention has utility;

FIG. 2 is a perspective view of a mechanical weeder in accordance with an embodiment of the invention;

FIG. 3 is a perspective view of a weeding assembly in accordance with an embodiment of the invention;

FIG. 4 is an elevational diagram of an operational feature of the weeding assembly of FIG. 3;

FIG. 5 is a plan diagram of an operational feature of the weeding assembly of FIG. 3;

FIG. 6 is second elevational diagram of an operational feature of the weeding assembly of FIG. 3;

FIG. 7 is an elevation view of a weeding assembly in accordance with another embodiment of the invention; and

FIG. 8 is an end view of the weeding assembly of FIG. 7.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, embodiments of the present invention generally provide a system for mechanically removing weeds in inter-plant spaces between fruit of nut bearing plants. More particularly, the present invention provides for such weed removal in areas that are adjacent the plants without producing physical damage to the plants.

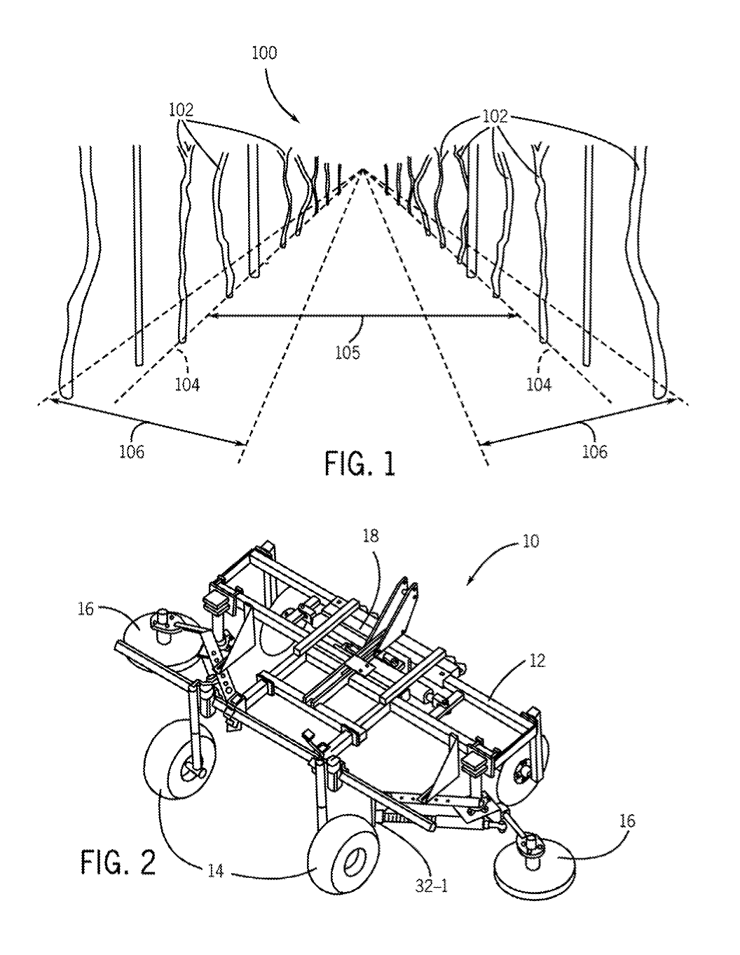

Referring now to FIG. 1, an exemplary agricultural setting in which the invention may have utility may be a grape vineyard 100. The vineyard 100 may comprise plants 102, arranged in rows 104. The plants 102 may be surrounded by berms 106. Space between the rows 104 may be referred as inter-row space 105.

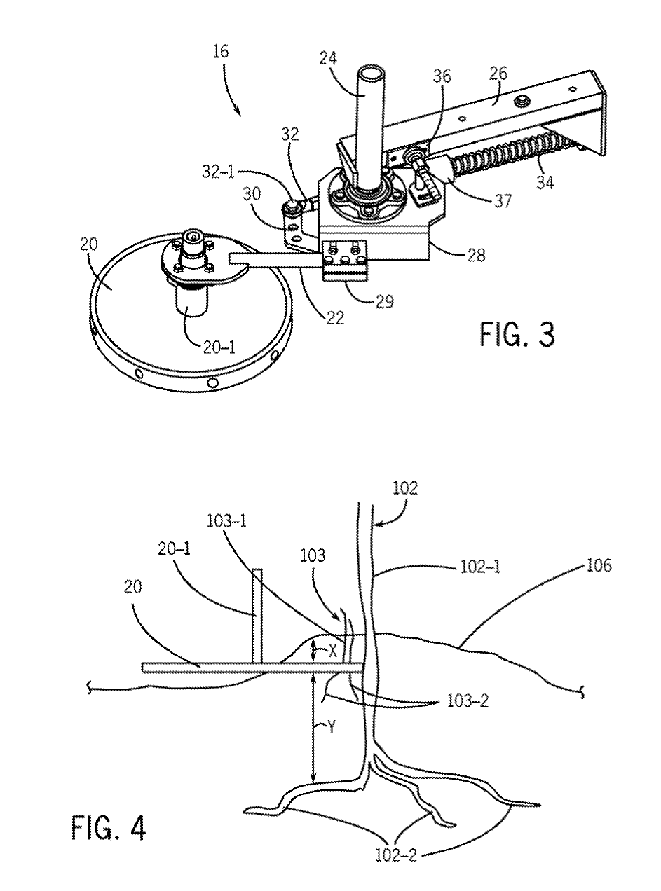

Referring now to FIGS. 2 and 3, there may be seen an exemplary embodiment of a mechanical weeder 10. The weeder 10 may be employed to remove weeds from the berms 106 of the vineyard 100 of FIG. 1. The weeder 10 may be attached to a front end of a tractor (not shown) and pushed between the rows 104 of the vineyard 100.

The weeder 10 may comprise a frame 12, wheels 14 and one or more weeding assemblies 16. Optionally, a width adjuster 18 may be provided so that lateral spacing between the weeding assemblies 16 may be altered to adapt the weeder 10 for use in vineyards having various spacing between their respective rows 104.

The weeder assembly 16 may comprise a rotatable weeder unit or weeder wheel 20, a wheel mounting arm 22, a pivot arm 24 and a connector arm 26. The pivot arm 24 and the connector arm 26 may be fixedly attached to the frame 12. A support member 28 may be rotatably attached to the pivot arm 24. A connecting link 30 may interconnect the support member 28 with a telescoping spring-biased arm 32 at a free end 32-1 of the arm 32. A fixed end 32-2 (see FIG. 2) of the arm 32 may be fixedly connected to the arm 26 which, in turn, may be fixedly connected to the frame 12. A compression spring 34 may be connected to spring bias the arm 32 into a nominal extended position in which a stop 36 may be engaged with arm 26. An adjustment collar 37 may be provided for precompressing the spring 34 to produce a desired force between the stop 36 and the arm 26.

Various operational features of the weeder 10 may be understood by referring to FIGS. 4, 5 and 6. In FIG. 4, it may be seen that the weeding wheel 20 may be progressively pushed through the berm 106 while being submerged under some soil of the berm 106. For example, the weeding wheel 20 may be submerged a distance X which may be about 2 inches. As the weeding wheel 20 passes through the berm 106, frictional engagement between the wheel 20 and the soil may cause the wheel 20 to rotate on an axis 20-1. Rotation of the wheel 20 may allow the wheel 20 to be pushed through the soil with relative ease.

As the wheel 20 strikes a weed plant 103, it may sever its upper foliage 103-1 from its roots 103-2 thus rendering the weed plant 103 unviable. It may be noted that the fruit-bearing plant 102 may have its roots 102-2 a distance Y below a top surface of the berm 106. The distance Y may be about 12 to 18 inches. Consequently, the weeding wheel 20 may pass over the roots 102-2 without contacting or damaging them.

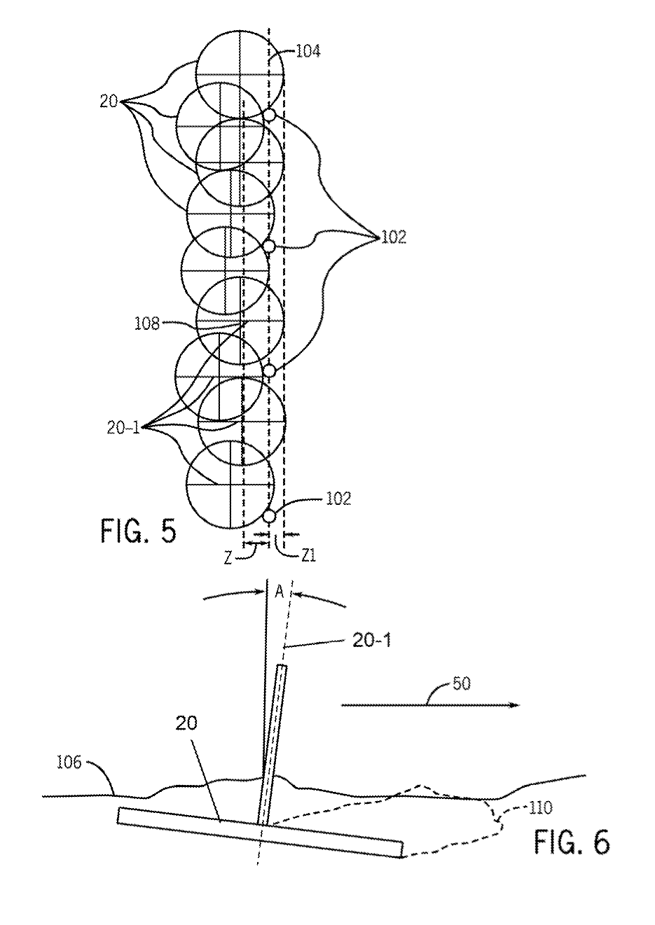

Referring now particularly to FIG. 5, it may be noted that when the weeding wheel 20 may strike a stem 102-1 of the plant 102, the wheel 20 may deflect away from the stem 102-1 as it rolls around the stem. In FIG. 5, a line 108 may represent a nominal position of the axis 20-1 of the wheel 20 as the weeder 10 may be pushed through one of the rows 104. It may be seen that when the wheel 20 is not in contact with any of the plants 102, the axis 20-1 of the wheel 20 may pass along the nominal line 108. As the wheel 20 comes close to one of the plants 102, the wheel 20 may be deflected so that its axis 20-1 may no longer be on the nominal line 108. (Such deflection may be accommodated by the spring-biased structural features described above with respect to FIG. 2). Deflection may begin before actual contact between the wheel 20 and the plant 102. This may occur because a wave 110 of disturbed soil see FIG. 6) may be pushed ahead of the wheel 20 as the weeder 10 progresses through the inter-row space 105. The wave 110 may produce back-pressure between the wheel 20 and the plant 102 thereby causing the wheel 20 to begin deflecting. Consequently, the plants 102 remain undamaged during operation of the weeder 10.

The weeder 10 may be advantageously operated so that a distance between Z between the lines 104 and 108 is less than a radius of the wheel 20. When operated in this manner, weed cutting action of the weeder 10 may overlap the row line 104. Consider, for example, an exemplary embodiment in which a diameter of the wheel 20 may be 18 inches. The weeder 10 may be adjusted in width and pushed so that the axis 20-1 of the wheel 20 may pass along the nominal line 108 at a distance Z of about 14 inches, thereby providing overlapping weed cutting for a distance Z1 of about 4 inches beyond the row line 104.

When operated with an overlap distance Z1 of about 4 inches, the weeder 10 may be pushed through one of the inter-row spaces 105 at a rate of about 4 miles per hour (mph) with a 40 horsepower (HP) tractor. If higher ground speed is desired, the overlap distance Z1 may be reduced.

In some soil conditions, it may be desirable to orient a plane of the wheel 20 into a non-horizontal position as shown in FIG. 6. The wheel 20 may be oriented so that its axis 20-1 may be positioned at an angle A relative to vertical and so that the axis 20-1 may be tilted toward a direction of travel of the weeder 10 (indicated by the arrow 50). In an exemplary embodiment, the angle A may be between 0° and about 10°. As the wheel 20 moves through the berm 106, the wave 110 of disturbed soil may develop and progress with the wheel 30. The wave 110 may advantageously produce back-pressure against the wheel 20 when the wave strikes one of the plants 102, thus providing force that may results in backward deflection of the wheel 20 and precluding damage to the plant 102.

Referring back to FIG. 2, it may be seen that variation of wheel-plane orientation may be achieved by rotating the arm 22 relative to the support 28 within an adjustable bracket 29.

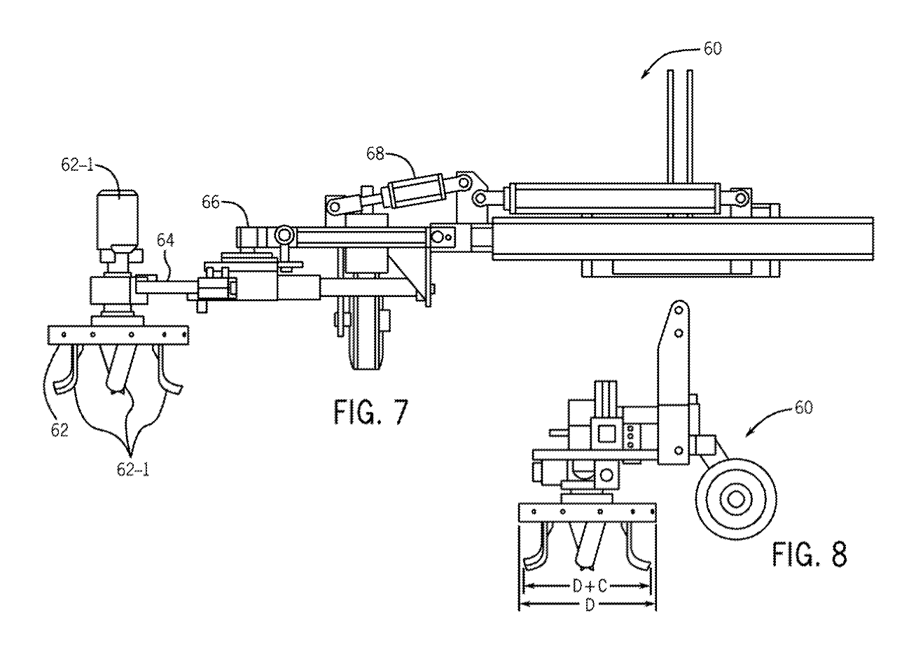

Referring now to FIGS. 7 and 8, another exemplary embodiment of a weeder assembly 60 may comprise, a deflecting tiller assembly 62 mounted on an arm 64 that may be rotatably connected to a pivot arm 66 in a manner similarly to the weeder assembly 16 of FIGS. 1 and 2. The tiller assembly 62 may comprise tiller tines 62-1 driven by a hydraulic motor 62-2 and a shield wheel 62-3. As may be seen particularly in FIG. 7, the tiller tines 62-1 may spin within a circle having a diameter D. The shield wheel 62-3 may have a larger diameter, D+C. It can be seen that, as the shield wheel 62-3 may come into contact with a fruit bearing plant such as an apple tree (not shown), the tiller assembly 62 may be deflected away from the tree in a manner similar to that of the weeder wheel 20 of FIGS. 1 and 2. The tiller tines 62-1 may never come into contact with the tree and thus may never inflict damage to the tree.

The weeder assembly 60 may be provided with a hydraulic cylinder 68 which may be employed to vary angularity of a rotational axis of the tiller tines 62-1 from an angle of about 30° above horizontal to about 15° below horizontal.

It should be understood, of course, that the foregoing relates to exemplary embodiments of the invention and that modifications may be made without departing from the spirit and scope of the invention as set forth in the following claims.

What is claimed is:

1. A mechanical weeder comprising:
a frame configured to be propelled by a motorized vehicle;
a rotatable weeder unit pivotally connected to a pivot arm attached to the frame; and
a spring connected to hold the rotatable weeder unit in a nominal pivotal position relative to the frame responsively to a force exerted by the spring.

2. The mechanical weeder of claim 1 wherein the rotatable weeder unit comprises a wheel connected to be freely rotatable about an axis of the wheel.

3. The mechanical weeder of claim 1 wherein the rotatable weeder unit comprises:
a hydraulic motor, and
tiller tines connected to be driven by the hydraulic motor.

4. The mechanical weeder of claim 3 wherein the rotatable weeder unit further comprises a shield wheel overlying the tiller tines, the shield wheel having a diameter greater than a diameter of a circle in which the tiller spin.

5. The mechanical weeder of claim 1:
wherein the frame is configured to be propelled along a directional axis;
wherein the frame has an outer side parallel to the directional axis; and
wherein the rotatable weeder unit is positioned outward of the outer side.

6. A deflectable weeder assembly attachable to a motorized vehicle comprising:
a pivot arm fixedly attachable to the vehicle;
a wheel freely rotatable about a wheel axis; and
a spring-biased wheel support rotatable about the pivot arm,
the wheel being connected to the spring-biased wheel support with the wheel axis being displaced from the pivot arm.

7. The weeder assembly of claim 6 wherein a plane of rotation of the wheel is adjustable relative to a plane of travel of the vehicle.

8. The weeder assembly of claim 7 further comprising:
a cylindrical wheel mounting arm interposed between the wheel and the wheel support; and
an adjustable bracket attached to the wheel support and configured to receive the cylindrical wheel mounting arm and hold the wheel mounting arm in a rotational position that corresponds to a desired orientation of the plane of rotation of the wheel.

9. The weeder assembly of claim 6 further comprising a compression spring connected to hold the wheel axis in a nominal position.

10. The weeder assembly of claim 9 wherein the compression spring is pre-compressed and an amount of pre-compression is adjustable.

11. A method for removing weeds from rows of fruit or nut bearing plants comprising the steps of:
inserting a portion of a wheel into a berm adjacent one of the rows;
pushing the wheel along the berm with a motorized vehicle while allowing the wheel to freely rotate about its wheel axis and while maintaining the wheel axis within 10° of vertical;
maintaining the wheel axis in a nominal position relative to the vehicle with a predetermined spring-bias force whenever the wheel is not subjected to wheel contact force that is less than the predetermined force;
allowing the wheel to deflect from the nominal position whenever the wheel contact force exceeds the predetermined spring-bias force.

12. The method of claim 11 wherein the step of inserting the wheel into the berm comprises positioning the wheel so that a top surface of the wheel is at a depth low enough to sever foliage from the weeds from roots of the weeds and so that a bottom surface of the wheel is high enough to not inflict damage on roots of the fruit or nut bearing plants.

13. The method of claim 11 wherein the wheel axis is maintained at an angle of about 5° to about 10° from vertical in a direction of travel of the wheel.

14. The method of claim 11 wherein the vehicle is moved along a line that results in the nominal position of the wheel axis being displaced from a row line of the fruit or nut bearing plants by a distance that results in an outer edge of the wheel overlapping the row line.

15. The method of claim 11 further comprising the step of setting spring bias force on the wheel so that wheel deflects as a result of wheel contact force that develops from contact between a wave of disturbed soil and one of the fruit or nut bearing plants.
